(19) United States
(12) Patent Application Publication
(10) Pub. No.: US 2017/0066551 A1
(43) Pub. Date: Mar. 9, 2017

(54) DISPOSABLE WASHOUT

(71) Applicants: George Sosa, Vacaville, CA (US); Leopoldo Alvares, Vacaville, CA (US)

(72) Inventors: George Sosa, Vacaville, CA (US); Leopoldo Alvares, Vacaville, CA (US)

(21) Appl. No.: 14/849,105

(22) Filed: Sep. 9, 2015

(51) Int. Cl. B65D 1/40; B08B 17/02

(52) U.S. Cl. CPC B65D 1/40; B08B 17/025

(57) ABSTRACT

A device for transporting waste includes a generally cylindrical hollow container having a top portion and a bottom portion, the top portion having an outer diameter which is larger than an outer diameter of the bottom portion, wherein the top portion and the bottom portion are of a cylindrical configuration having a common center; and two elongated parallel recesses positioned on the bottom portion, the parallel recesses extending from one side of the bottom portion through the opposite side of the bottom portion and equidistant from the common center, wherein the parallel recesses are adapted to receive forklift arms.

### BACKGROUND

The invention generally relates to concrete cleaning facilities and methods for cleaning concrete-related machines and tools.

Concrete washout is a term used to describe the process of cleaning a concrete or ready-mix truck after it delivers its contents at a worksite. After pouring liquid cement, a truck operator must wash off the concrete delivery shoot and other equipment before the concrete hardens onto these surfaces. The water used to clean off the equipment mixes with and becomes contaminated with the product. This contaminated washout water must not be allowed to escape into the surrounding storm drains and ground water as it can contain an extremely high amount of dangerous contaminates which could get into nearby water sources.

Most states now impose strict, complex environmental regulations for operators at construction sites for the containment and removal of concrete, cement, mortar and/or paint washout runoffs. These regulations are cumbersome and complicated, including rules regarding container structure specifications, allowable placement of such containers on site, and even materials to be used for such containers. A violation of these local rules can result in the imposition of expensive fines and possible quasi-criminal penalties.

Typically large construction sites provide for washout of excess concrete from concrete pumps, ready mix trucks, and other tools and implements by providing either a large pond lined with plastic or a large metal tub. The pond or tub collects the washout water and excess concrete so as not to contaminate the area. At the end of the job or when the facility is full the contractor faces a difficult and expensive job of removing the waste water and concrete.

For smaller jobs the ready mix trucks still need a place to wash out their chutes and other implements need to be cleaned, and trailer concrete pumps need to be washed out. Federal and many local governments are passing strict rules and laws to protect the environment from pollution on construction sites.

### SUMMARY

A device for transporting waste includes a generally cylindrical hollow container having a top portion and a bottom portion, the top portion having an outer diameter which is larger than an outer diameter of the bottom portion, wherein the top portion and the bottom portion are of a cylindrical configuration having a common center; and two elongated parallel recesses positioned on the bottom portion, the parallel recesses extending from one side of the bottom portion through the opposite side of the bottom portion and equidistant from the common center, wherein the parallel recesses are adapted to receive forklift arms.

Advantages of the system may include one or more of the following. The system is light weight, meaning that prior to use, the washout can be moved around with ease to place in need either place in back of truck to carry around or taken to different areas of job without equipment. Various diameter containers can be made in advance, so that the containers are available in different sizes to fit in different places and choose the right size needed for job. The container has two areas open at bottom for forklift to pick up and dispose after being used.

The system overcomes the disadvantages and shortcomings of the problems of the prior art by providing a washout system that is easy to transport and quick to use at a desired construction site location. The washout also uses appropriate materials for containing washout water that comply with local regulations while still providing a simple, time-effective, and easily usable washout system.

The washout system is easily transportable to any desired location wherein the surface on which it is placed is essentially flat. The washout system can be placed on a grassy surface, concrete, or asphalt for example. It can be placed on a slightly sloping surface as well. The ultimate location of the washout system is one the complies with any state regulation yet is a convenient location in which an operator can perform a washout, for example at a location in which an operator has easy access to a water hose, and in which the location does not interfere with ongoing work or create a hazard. Because of its flexible transportability, the washout system of the invention is easy to place wherever desired.

Additional features and benefits of the concrete washout system will be apparent from the detailed description which follows, particularly when read in conjunction with the accompanying figures.

### BRIEF DESCRIPTION OF THE DRAWINGS

The foregoing and other features, aspects and advantages of the present invention are described in detail below with reference to the drawings of various embodiments, which are intended to illustrate and not to limit the invention. The drawings comprise the following figures in which:

FIG. 1 illustrates a top view of the portable concrete washout container of FIG. 1;

FIG. 2 illustrates a side elevation view of an exemplary portable concrete washout container;

FIG. 3 illustrates an embodiment of the portable concrete washout container in operation with a concrete mixing truck.

FIG. 4 illustrates an embodiment of the portable concrete washout container in operation with a forklift.

### DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

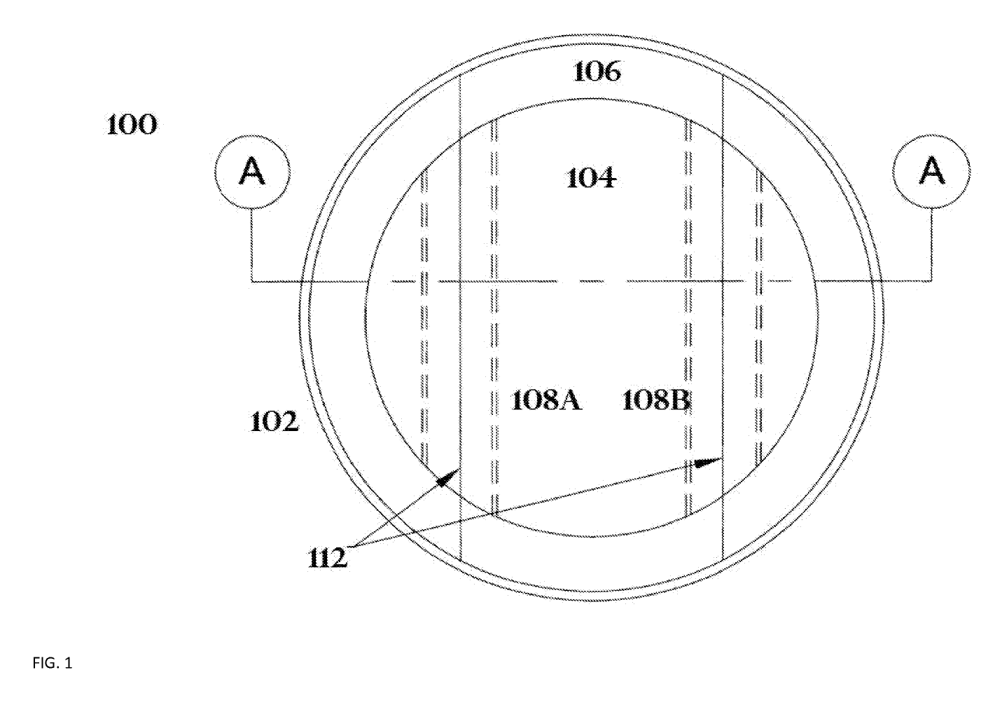

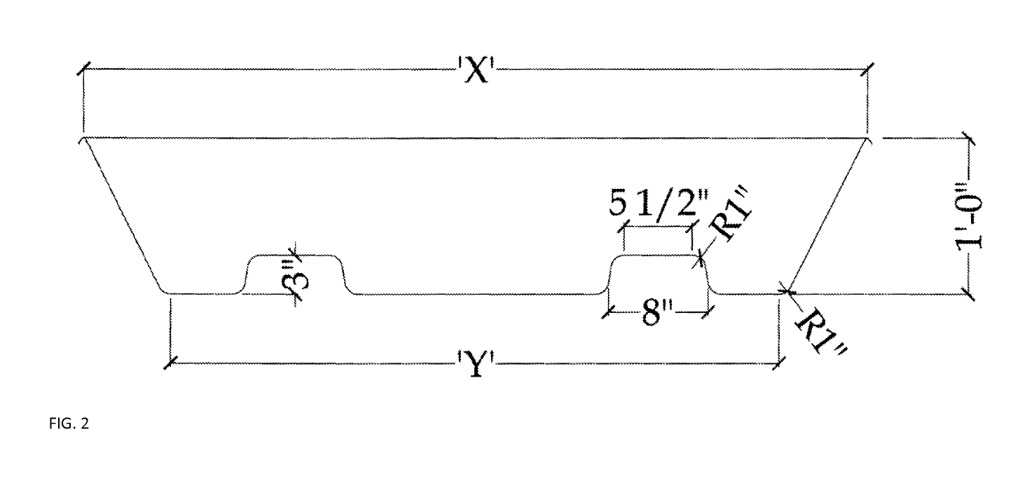

FIG. 1 illustrates a top view of an exemplary portable concrete washout device 100 while FIG. 2 illustrates a side elevation view of the portable concrete washout device of FIG. 1. Viewing FIGS. 1-2 together, the device 100 forms a generally cylindrical hollow container having a top portion 102 and a bottom portion 104, the top portion 102 having an outer diameter which is larger than an outer diameter of the bottom portion 104, wherein the top portion and the bottom portion are of a cylindrical configuration having a common center. A slanted wall 106 is formed between the top and bottom portions 102 and 104, respectively.

Supports on the washout unit are configured to provide stability when in use and to simplify delivery and pickup of the washout unit. To that end a pair of stabilizer skids is preferably attached to the bottom of the container which are configured for guiding the container onto or off of a truck adapted for transporting the container. The washout container 100 has two areas open at bottom for forklift to pick up and disposed of after capturing wastes such as used cement compositions. This is accomplished through two elongated parallel recesses 108A and 108B positioned on the bottom portion 104. The parallel recesses 108A and 108B extends from one side of the bottom portion 104 all the way through the opposite side of the bottom portion 104. The recesses 108A and 108B are symmetrical and positioned equidistant from the common center. The parallel recesses are adapted to receive forklift arms. For stability reasons, the recesses must be centered to fit the fork arms. The forklift can move the device 100 to properly dispose of the wastes such as used cement mixtures, among others.

FIG. 2 shows a top down view of an exemplary concrete washout device 100. From this view, an outside lip of the device 100 is clearly visible. The device is comprised of a surrounding angled wall 106 connecting the top and bottom portions 102 and 104. The surrounding angled wall 106 is attached to an outside edge 110 of the circular base 104. Surrounding angled wall 106 and circular base 104 form the basic shape of the concrete washout device 100. The base 104 of the concrete washout container 100 is substantially flat, with the exception of two elevated surfaces or recesses, 108A and 108B.

In one embodiment, the device 100 has a generally cylindrical hollow container having a top portion and a bottom portion, the top portion and bottom portion having diameters in pairs selected from the group in ratios of 3:2, 4:3, and 5:4 respectively, wherein the top portion and the bottom portion are of a cylindrical configuration having a common center.

In this embodiment, two elongated parallel recesses are positioned on the bottom portion, the parallel recesses extending from one side of the bottom portion through the opposite side of the bottom portion and equidistant from the common center. The parallel recesses are adapted to receive forklift arms, wherein the recess has a height of about 3 inches and length of about 8 inches.

FIG. 2 shows a cross-sectional cutaway view of the concrete washout device 100 along line A-A of FIG. 1, where the shape of the container becomes apparent. The device 100 has a generally trapezoidal shape delineated by the angled wall 104. The container has two clear width dimensions, an upper diameter and the lower diameter. The upper diameter is generally larger than the lower diameter. The circular base 104 and raised surfaces 108A and 108B can also be seen at the bottom of the container. The raised surfaces 108A and 108B receive underlying forklift operation arms 114A and 114B. The slots allow for forklift arms to slide underneath and lift the concrete washout device 100 after capturing cement wastes. The device 100 helps to collect the cement washout from any cement distribution device by causing the washout to collect at the bottom of the concrete washout device 100.

Exemplary dimensions for FIG. 2 can be as follows:

| X′ | Y′ |
|---|---|
| 3′-0″ | 2′-0″ |
| 4′-0″ | 3′-0″ |
| 5′-0″ | 4′-0″ |

The disposable washout is preferably made of plastic about 1.5 may be 2 mm Injection mold in one embodiment. The washout is light weight and before using, it can be moved around with ease to place in need either place in back of truck to carry around or taken to different areas of job without equipment. The washout comes in different sizes to fit in different places and the user can simply choose the right size needed for job.

Optionally, the washout unit can be configured with one or more coupling structures, such as a hitch or hook 112 for being engaged during loading. Furthermore, mechanical couplings are preferably incorporated for attaching a hoist or similar means of lifting and/or tilting the washout unit, such as for moving the washout container and/or tilting the unit to remove solid waste materials. The unit also has two straps on sides to remove the plastic washout from concrete in jobs or areas where plastic and concrete cannot mix when disposing (this may be optional).

Wet waste concrete and liquid washout may be deposited in the washout device 100 from a cement mixer, or other concrete conveyance means, and concrete tool cleanup operations, without creating an environment hazard. Excess liquid can be pumped off into container vehicles for transport for recycling, allowing the washout container to be utilized for a longer period of time before it needs to be removed from the site. It should be appreciated that the washout container can be retained at the site until enough solid concrete waste materials build up to curtail further washout operations. The solid material of the waste concrete can be dumped from the washout container and broken up for use as a fill material. The invention therefore is adapted to simplify both the loading of concrete and waste water into the washout container, and for subsequently unloading the solid concrete waste materials.

The washout container may also be used in a method of controlling concrete washout, comprising the steps of: (1) delivering a washout container at a site for collecting solid and liquid concrete waste material during the washout process from vehicles driven up on ramps attached to the washout container; (2) servicing the washout container in response to usage at the site by removing excess liquid waste from the washout container and hauling it away; and (3) picking up the washout container with collected concrete waste material from the site.

The excess water in the washout container may be removed in any convenient manner, such as by pumping or decanting. It is preferable that the washout container be periodically serviced, such as for removing excess liquid which allows retaining a given washout container on site for a longer period of use, such as until the buildup of solid concrete waste material limits continued washout activity. Once filled, the solid concrete materials are emptied from the washout container for processing or disposal. The solid material is preferably emptied by opening the door and tilting the container, or otherwise applying an urging (extraction) force upon the retained concrete waste material to remove it from the container. The use of pumps and mobile liquid collection reservoirs are preferably incorporated within separate vehicles, or incorporated within the trucks configured for delivering and collecting the washout containers. By way of example fluid tanks may be attached beneath or on the side of the truck chassis, thereby providing a vehicle that can pump off liquids prior to collecting a washout container or that may pump liquids from washout containers other than those being delivered or collected.

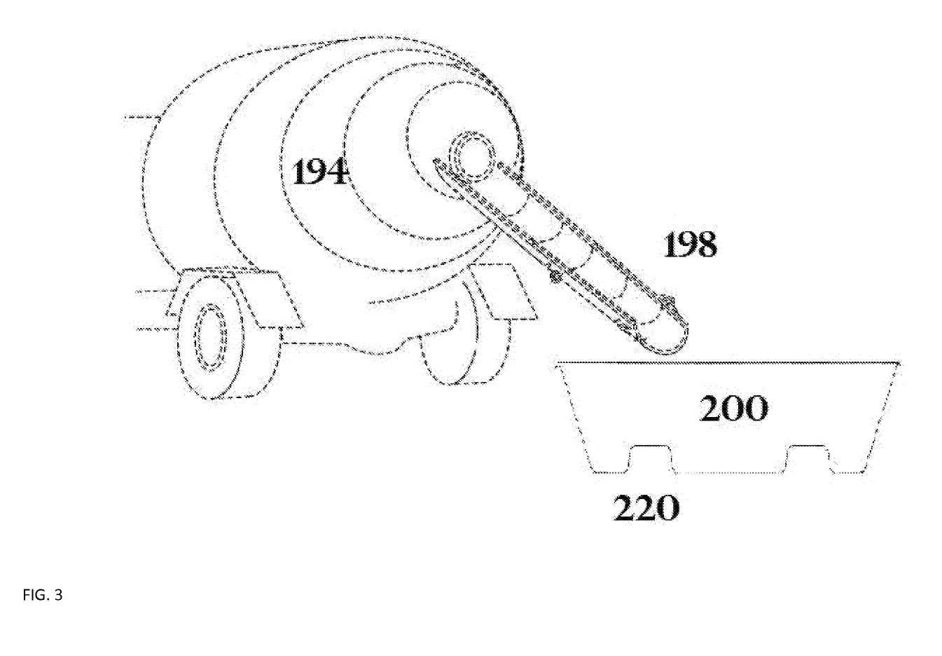

FIG. 3 shows an exemplary concrete distribution device 194 used in conjunction with the concrete washout device 200. FIG. 3 depicts exemplary operation of the device of FIG. 1 installed under chute of a ready mix truck, such that residual concrete waste material will fall into device 100. In one embodiment, the chute of ready mix truck is located to the side of the centerline of ready mix truck. Device 100 is secured under chute of ready mix truck by use of straps (not shown), wherein the straps include carabiners located thereon, and wherein carabiners attach to hooks or rings on a spout of the ready mix truck.

FIG. 3 shows apparatus 200 installed under hopper/agitator 194, or similar truck. Concrete that may spill from hopper/agitator or truck, or residual concrete that is removed from hopper/agitator or truck 194 through clean-out, will be contained by container 200, thereby preventing environmental contamination. Container 200 is placed on ground in the area where the hopper/agitator or truck 194 will be stationed. The hopper/agitator or truck 194 will then drive onto floor of apparatus 200, such that the discharge area of hopper/agitator 194 will be over container 200. Upon completion of operations, the hopper/agitator or truck 194 is washed and waste is stored in container 200 before being driven away, leaving waste contained within apparatus 200. Straps 2 may be used to transport apparatus once it is full and solidified, or otherwise no longer needed.

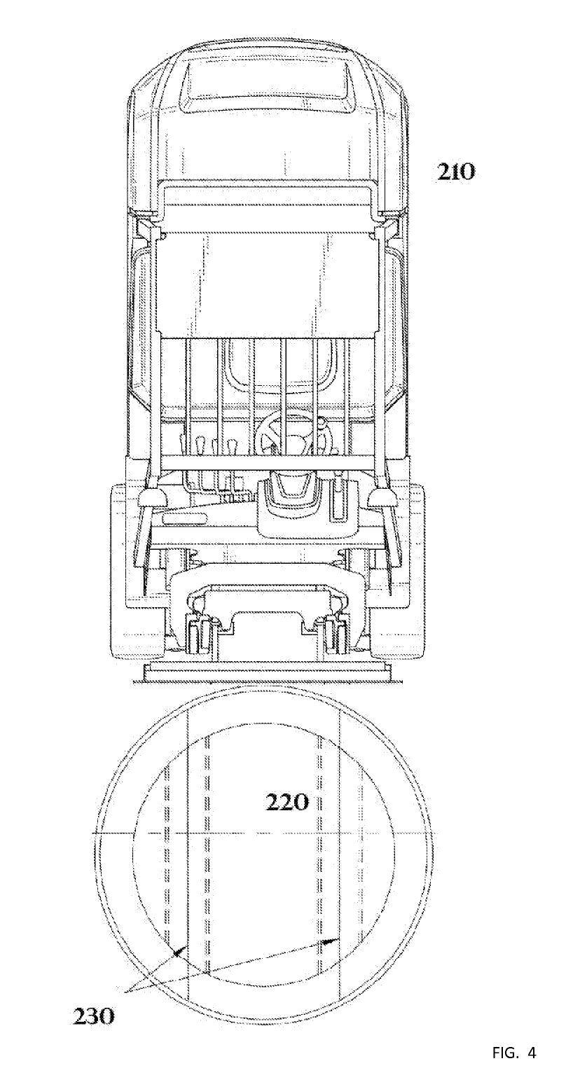

The washout container 200 sits on a surface level with the concrete distribution device 194. A tunnel or chute 198 delivers concrete waste to the washout container 200. Upon completion, a forklift 210 can be used to move the washout container 200 for disposition. As shown in FIG. 4, the forks or arms are driven into the recesses 230 to engage the container 200. The forklift operator can then move the container 200 to a suitable disposal location.

In one embodiment, the container 200 is designed for a predetermined maximum weight with a specified forward center of gravity. Forklifts are rated for loads at a specified maximum weight and a specified forward center of gravity. This information is located on a nameplate provided by the manufacturer, and loads must not exceed these specifications. Another characteristic of the forklift is its instability. The forklift and container is considered a unit with a continually varying center of gravity with every movement of the container. A forklift must never negotiate a turn at speed with a raised load, where centrifugal and gravitational forces may combine to cause a disastrous tip-over accident. The forklift are designed with a load limit for the forks which is decreased with fork elevation and undercutting of the container load (i.e., when a load does not butt against the fork “L”). A loading plate for loading reference is usually located on the forklift. A forklift should not be used as a personnel lift without the fitting of specific safety equipment, such as a “cherry picker” or “cage”.

SAFE WORKING LOADS (S.W.L.)
MATERIAL SPECIFICATION SAE 15B37H MOD

| Cross Section | | LBS Per Fork |
|---|---|---|
| Width × Thickness | | @ 24 inch |
| ‘W ’(mm) × ‘T ’(mm) | | Load Centre |
| | KGS Per Fork @ 500 mm | |
| | Load Centre | |
| 60 × 40 | 900 | 1625 |
| 80 × 40 | 1200 | 2170 |
| 100 × 30 | 840 | 1515 |
| 100 × 40 | 1500 | 2710 |
| 100 × 45 | 1900 | 3430 |
| 100 × 50 | 2340 | 4220 |
| 120 × 40 | 1800 | 3250 |
| 120 × 45 | 2270 | 4100 |
| 120 × 50 | 2800 | 5050 |
| 125 × 40 | 1870 | 3375 |
| 125 × 45 | 2370 | 4275 |
| 125 × 50 | 2920 | 5270 |
| | KGS Per Fork @ 600 mm | |
| | Load Centre | |
| 150 × 50 | 2920 | 6320 |
| 150 × 60 | 4200 | 9090 |
| 150 × 65 | 4940 | 10700 |

STANDARD HOOK-TYPE MOUNTING

| CARRIAGE DIMENSIONS | |
|---|---|
| ‘X’ | ‘Y’ |

| CLASS | mm | inches | mm | inches |
|---|---|---|---|---|
| 1A | 76 | 3 | 331 | 13 |
| 1B | 114 | 4½ | | |
| 2A | 76 | 3 | 407 | 16 |
| 2B | 152 | 6 | | |
| 3A | 76 | 3 | 508 | 20 |
| 3B | 203 | 8 | | |
| 4A | 127 | 5 | 635 | 25 |
| 4B | 254 | 10 | | |

STANDARD FORK ARM LENGTHS ‘L’

| | Inches | | | | | | |
|---|---|---|---|---|---|---|---|
| | 36 | 42 | 48 | 54 | 60 | 72 | 96 |
| MM | 915 | 1067 | 1220 | 1372 | 1524 | 1830 | 2438 |

It is envisioned in an alternative embodiment that the device 100 or 200 may be fabricated from any porous material that would permit water to seep or weep therethrough, yet be strong and puncture resistant enough to function for the uses and purposes provided herein.

It is further envisioned in alternate embodiments that the device of the present invention may be made from a water impermeable material; or, may be lined, internally or externally, with a water impermeable material; or, may be chemically treated in order to obtain water impermeable characteristics. This would facilitate the capture of priming agent and the first concrete material to pass out of a pump in areas where it would be undesirable for liquid, including water, to exit the device.

It is also conceived that in an alternate embodiment, the straps may be bungee-type cords, springs, resilient rubber cords, or the like, or the straps could be made of webbing material.

It is still further conceived in an alternate embodiment that device 100 could be generally of round cross-section.

It is still further conceived in an alternate embodiment that device 100 could be of any round-bottomed or generally circular shape, as in, for example, a parachute-like configuration.

It is yet further contemplated in an alternate embodiment that device 100 could be of generally prismatic shape or of generally polygonal cross section.

As has been described with regard to the various embodiments of FIGS. 1-3, the device 100 is suitable for use in collection of concrete. Accordingly, in use and operation, a source of concrete to be collected is provided. At least one device for containing concrete to be collected is attached to the source. Apparatus 100 may be supported by the source of concrete to be collected, as by hook-and-loop fasteners, clips, clamps, or the like, or may otherwise be oriented under, proximate, or adjacent to the source of concrete to be collected. The concrete to be collected then is allowed or made to flow into device 100 through an opening therewithin.

It will be understood that a person skilled in the art may make many variations and modifications without departing from the spirit and the scope of the present invention. For example, the washout system could be used for other kinds of runoff other than concrete. The washout system could be used to collect solid waste materials as well. The side drawstrings could attach to the vertical frame legs by means other than the drawstring clamps. Further stabilizing structure could be added include more tie downs. All such variations and modifications, including those discussed above, are intended to be included within the scope of the present invention as defined in the appended claims.

Although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the novel methods and systems described herein may be embodied in a variety of other forms without departing from the spirit thereof. Accordingly, other combinations, omissions, substitutions and modifications will be apparent to the skilled artisan in view of the disclosure herein. Accordingly, the present invention is not limited to the specific embodiments illustrated herein, but is limited only by the following claims.

What is claimed is:

1. A device for transporting waste comprising:
a generally cylindrical hollow container having a top portion and a bottom portion, the top portion having an outer diameter which is larger than an outer diameter of the bottom portion, wherein the top portion and the bottom portion are of a cylindrical configuration having a common center;
two elongated parallel recesses positioned on the bottom portion, the parallel recesses extending from one side of the bottom portion through the opposite side of the bottom portion and equidistant from the common center, wherein the parallel recesses are adapted to receive forklift arms.

2. The device of claim 1, wherein the container is preformed from plastic.

3. The device of claim 2, wherein the plastic is preformed from: injection molding.

4. The device of claim 2, wherein the container is disposable and is made of plastic with about one to three millimeters of injection molding and wherein the container is stored in a truck back.

5. The device of claim 1, wherein the container is molded in a plurality of sizes for a particular job.

6. The device of claim 1, comprising one or more coupling structures coupled to the container to facilitate moving the container.

7. The device of claim 1, comprising a hitch or hook coupled to the container during loading, moving or tilting the container to remove the waste.

8. The device of claim 1, comprising two straps on container sides to remove the container from concrete in jobs or areas where plastic and concrete cannot mix when disposing the concrete.

9. The device of claim 1, wherein the container is stackable with another container.

10. The device of claim 2, wherein the container when fully loaded comprises a predetermined maximum weight with a specified forward center of gravity.

11. A device for transporting waste comprising:
a generally cylindrical hollow container having a top portion and a bottom portion, the top portion and bottom portion having diameters in pairs selected from the group in ratios of 3:2, 4:3, and 5:4 respectively, wherein the top portion and the bottom portion are of a cylindrical configuration having a common center;
two elongated parallel recesses positioned on the bottom portion, the parallel recesses extending from one side of the bottom portion through the opposite side of the bottom portion and equidistant from the common center, wherein the parallel recesses are adapted to receive forklift arms, wherein the recess has a height of about 3 inches and length of about 8 inches.

12. The device of claim 11, wherein the container is preformed from plastic.

13. The device of claim 12, wherein the plastic is preformed from: injection molding.

14. The device of claim 12, wherein the container is disposable and is made of plastic with about one to three millimeters of injection molding.

15. The device of claim 11, wherein the container is stored in a truck back and wherein the container is molded in a plurality of sizes for a particular job.

16. The device of claim 11, comprising one or more coupling structures coupled to the container to facilitate moving the container.

17. The device of claim 11, comprising a hitch or hook coupled to the container during loading, moving or tilting the container to remove the waste.

18. The device of claim 11, comprising two straps on container sides to remove the container from concrete in jobs or areas where plastic and concrete cannot mix when disposing the concrete.

19. The device of claim 11, wherein the container is stackable with another container.

20. The device of claim 12, wherein the container when fully loaded comprises a predetermined maximum weight with a specified forward center of gravity.
